(19) United States
(12) Patent Application Publication
(10) Pub. No.: US 2004/0133381 A1
(43) Pub. Date: Jul. 8, 2004

(54) Control scheme for spatial and level searching of a panoramic stabilized periscope

(76) Inventor: Ping-Ho Chen, Taipei (TW)

Correspondence Address: JOHNSON & ASSOCIATES PC, 14625 BALTIMORE AVENUE #282, LAUREL, MD, 20707, US

(21) Appl. No.: 10/334,718

(22) Filed: Jan. 2, 2003

(51) Int. Cl. G01C 9/00

(52) U.S. Cl. 702/153

(57) ABSTRACT

This invention relates to a control method for spatial and level searching applied to a panoramic stabilized periscope especially for use in military vehicles. The control method of the present invention uses platform altitude angles including heading, pitch, roll and spatial level constant elevation angle pointer vector as inputs, and periscope gimbal azimuth angle (AZ) and elevation angle (EL) command as outputs.

### BACKGROUND OF THE INVENTION

1. Field of the Invention

The present invention relates to a control method for spatial and level searching applied to a panoramic stabilized periscope of military vehicles. More specifically, the present invention relates to an automatic vision tracking system for improving spatial and level searching control method applied to panoramic stabilized periscope of military vehicles.

2. Related Prior Art

Traditional periscope head mirror of military vehicles has a single elevation axis (EL) design, and the target acquisition is based on the azimuth (AZ) of the gun turret, which is independently unable to search for panorama through its azimuth rotation, and thus unable to record and process the panorama for automatic vision tracking (AVT).

Recent improvements have equipped periscopes with dual axes drive (AZ & EL), but there still exist no platform gyroscope for correlation when the platform is tilted. Therefore, modern improvements have failed to control the target position in the three dimensional spatial coordinates.

### SUMMARY OF THE INVENTION

An object of the present invention is to apply a control method of spatial and level searching to a panoramic stabilized periscope, wherein the inputs are platform altitude angles, including heading, pitch, roll and spatial level constant elevation angle pointer vector, and the outputs are periscope gimbal azimuth angle (AZ) and elevation angle (EL) command.

Another object of the present invention is that after transforming the inputted platform altitude three times, the relative level spatial unit vector of the platform three axes can be calculated.

Another object of the present invention is that to use the inputted spatial pointer level constant elevation angle to calculate its relative level spatial unit vector, and the vector is level constant speed scan vector.

Another object of the present invention is that the method is based on solid analytical geometry and projection vector matrix method, and the unit vector of the spatial pointer level constant elevation angle projects the vector onto the three axes of platform.

Still, another object of the present invention is that the platform three axes projection vector is normalized.

A further object of the present invention is that the orthogonal polarization control rule of said spatial level searching scan can he accomplished by aiding the coordinate transformation of the vision processing.

Still, a further object of the present invention is that after actually controlling the gimbal's command, the errors of the gimbal control and the vision tracking can be transformed into actual spatial level pointer to correct their respective errors.

The present invention will be readily apparent upon reading the following description of a preferred exemplified embodiment of the invention and upon reference to the accompanying drawings.

### BRIEF DESCRIPTION OF THE DRAWINGS

FIG. 1 illustrates three dimensional spatial spherical coordinates.

FIG. 2 illustrates block diagram of the operational environment.

FIG. 3 illustrates input and output of the control rule.

FIG. 4 illustrates the gyroscope gimbal.

FIG. 5 illustrates the periscope's head mirror gimbal (normal state).

FIG. 6 illustrates flow chart control.

FIG. 7 illustrates three times sequence transformation of the coordinates.

FIG. 8 illustrates an analytical description for commanding the periscope's head mirror gimbal angle.

FIG. 9 illustrates the control flow of the level constant elevation angle.

FIG. 10 illustrates three dimensional analytical diagram of the level constant elevation angle.

FIG. 11 illustrates the coordinates transformation of the gimbal.

FIG. 12 illustrates the orthogonal polarization rolling angle.

### DETAILED DESCRIPTION AND PREFERRED EMBODIMENTS

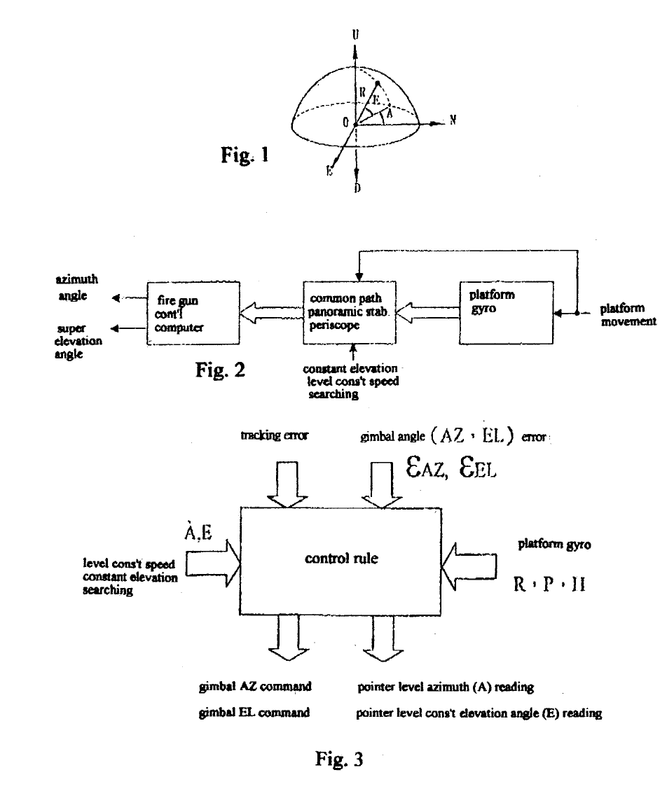

FIG. 1, shows a three dimensional spatial spherical coordinate to illustrate the target positioning in the solid spatial coordinate for a panoramic stabilized common-optical-path periscope. The bottom plane of the coordinate is at a local level; that is, composed of local north (N) and east (E) levels to form a basic plane.

Referring to FIG. 1, the right hand rule shows two possible coordinates: N E D or E,N,U coordinate. The target positioning is A ER (spherical coordinate), wherein A is the Azimuth, B is the Elevation angle, and R is the range. The searching scan type is represented by the following parameters: constant speed level scan, wherein A=constant and E=0; constant speed constant elevation angle spatial scan, wherein A=Const and E>0.

Still referring to FIG. 1, because there exist an actual pointer control error and vision tracking error of the head mirror gimbal, there is a need to precisely transform the actual pointer direction into a level pointer reading, so as to position and record the vision for the periscope.

FIG. 2 shows a block diagram of the operational environment. After the gyrocompass detects platform movement together with a constant elevation angle level command and a constant searching command to input to the panoramic stabilized common optical-path-periscope, the panoramic stabilized common optical path periscope outputs the target data for firing the gun control computer, which in turn commands the firing gun azimuth angle and the super elevation angle.

FIG. 3, shows the inputs of the level searching control rule, including the platform gyrocompass, the gimbal angle error, the tracking error and the constant search speed elevation angle. FIG. 3 also shows the outputs, including gimbal AZ command, gimbal EL command and the pointer level azimuth angle (A) readings and the pointer level elevation angle (E).

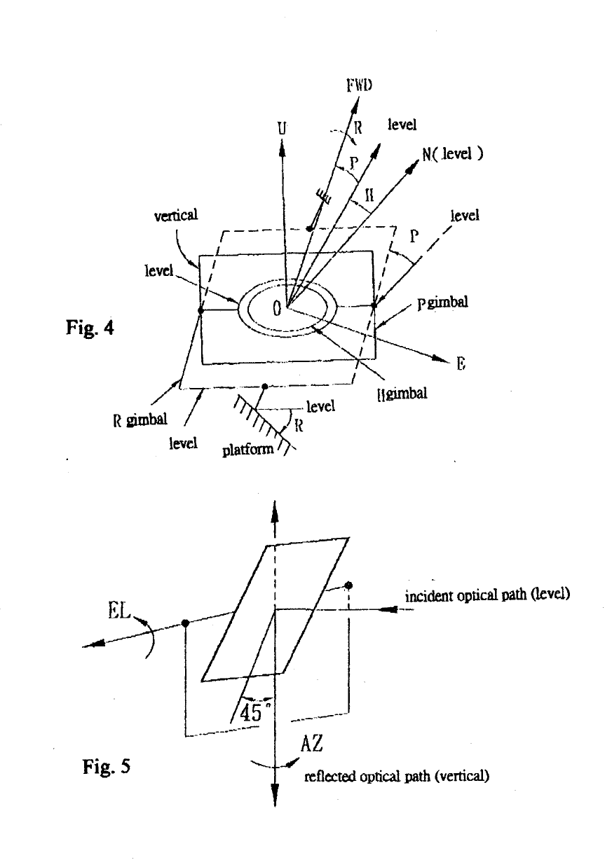

Referring to FIG. 4, is shown a perspective view of the gyroscope gimbal, wherein the gimbal of the gyroscope a composition structure from top to bottom includes the Heading (H), the Pitch (P) and the Roll (R). H, R and P are in sequence, where H indicates a gimbal with level pointing to the north, P indicates a gimbal in an orthogonal direction and R indicates a gimbal in a level direction.

FIG. 5 shows a periscope head mirror gimbal in its normal state erected in a composition structure, wherein from top to bottom EL and AZ are in sequence. The head mirror is mounted on the EL axis relative to incidence light of the mirror surface tilted 45 degree with respect to the horizontal level, thus the reflected light can follow the negative AZ axis vertically downward.

The main purpose for generating the head mirror level searching command is to maintain a 360 degree panoramic vision by performing a level search to superimpose the visual pictures, while the target search is at a level constant scan speed. The periscope motor axis is controlled so as to keep the pointer direction right on the level plane, thus the incident optic path will be reflected by the reflection surface and will follow the Z axis of the common optical path of the electrograph machine to obtain a vision. As for the target control (the direction of gimbal pointer), the elevation angle relative to level the surface is E=0, and the azimuth angle rate relative to the level surface is \dot{A}=Const=Ω.

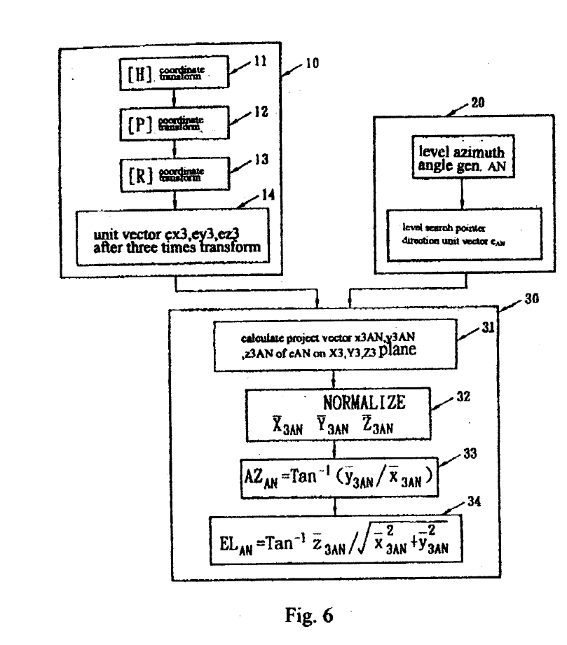

Now referring to FIG. 6, a flow chart control is shown, wherein coordinate transformation module 10 adopts a three axes coordinate sequentially to transform H coordinate 11, P coordinate 12 and R coordinate and then calculate unit vector 14 eₓ₃,e_{y3},e_{z3} of X₃, Y₃, Z₃ in its axial direction.

Meanwhile, level searching scan vector module 20 based on scanning speed calculates the level azimuth A_{N} with fixed time interval 21, and then A_{N} proceeds to transform the unit vector e_{AN} 22 in the level searching pointer direction. After the coordinate transformation module 10 and the level vector module 20 is complete, then calculation 30 of the angle command of the head mirror gimbal AZ_{N} and EL_{N} is performed. The calculation process first calculates 31 the level projection vectors X_{3AN}, Y_{3AN} and Z_{3AN} on the X₃, Y₃, Z₃ plane and then calculates 32, the normalization for these three projection vectors. Finally, the process calculates 33 and 34 the angle command of the head mirror gimbal AZ_{AN} and EL_{AN} respectively.

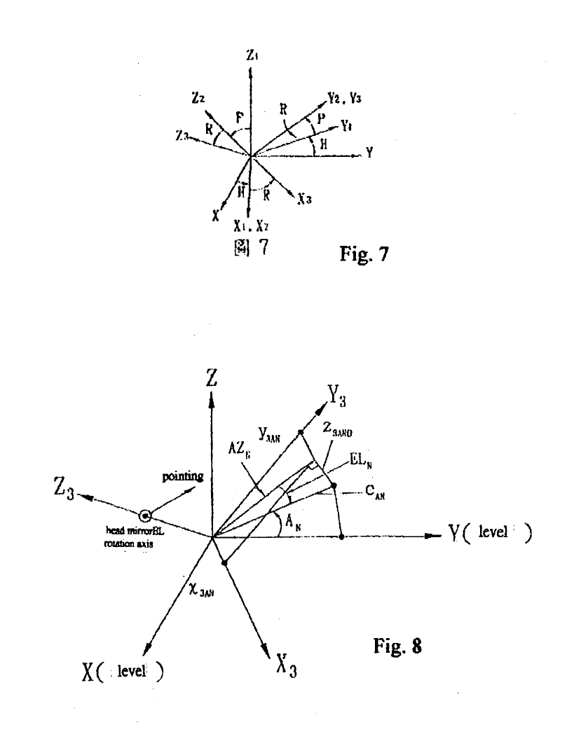

FIG. 7 shows the three times transformation sequence of the coordinates. The rules governing the coordinates transformation module 10, the level searching vector module 20 and the head mirror gimbal angle command 30 are respectively delineated in the following sections below:

Section A—The Rule Governing the Coordinates Transformation Module 10.

$$( 1 ) [ H ] = [ \begin{matrix}Cos H & Sin H & 0 \\ - Sin H & Cos H & 0 \\ 0 & 0 & 1\end{matrix} ] , [ P ] = [ \begin{matrix}1 & 0 & 0 \\ 0 & Cos P & Sin P \\ 0 & - Sin P & Cos P\end{matrix} ] , \\ [ R ] = [ \begin{matrix}Cos R & 0 & Sin R \\ 0 & 1 & 0 \\ - Sin R & 0 & Cos R\end{matrix} ] ;$$

and

(2) coordinates transformation sequence └H┘→[P]→[R]

three axes unit vector are illustrated as

$$[ \begin{matrix}{e}_{X3X} \\ {e}_{Y3X} \\ {e}_{Z3X}\end{matrix} ] = [ R ] [ P ] [ H ] [ \begin{matrix}1 \\ 0 \\ 0\end{matrix} ] , [ \begin{matrix}{e}_{x3y} \\ {e}_{y3y} \\ {e}_{z3y}\end{matrix} ] = [ R ] [ P ] [ H ] [ \begin{matrix}0 \\ 1 \\ 0\end{matrix} ] , and [ \begin{matrix}{e}_{x3z} \\ {e}_{y3z} \\ {e}_{z3z}\end{matrix} ] = [ R ] [ P ] [ H ] [ \begin{matrix}0 \\ 0 \\ 1\end{matrix} ] \\ \to {[ \begin{matrix}{e}_{x3 ,} & {e}_{y3 ,} & {e}_{z3}\end{matrix} ]}^{T} = [ R ] [ P ] [ H ] [ \begin{matrix}1 & 0 & 0 \\ 0 & 1 & 0 \\ 0 & 0 & 1\end{matrix} ] \\ \to {[ \begin{matrix}{e}_{x3 ,} & {e}_{y3 ,} & {e}_{z3}\end{matrix} ]}^{T} = [ R ] [ P ] [ H ]$$

Section B—The Rule Governing the Level Searching Vector Module 20.

The generation of the level azimuth angle A(t) number array is (A₁,A₂, - - - A_{N}, - - - ); and

if A(t)=Const=Ω

then ΔA/Δt=Ω(Δt→0)

→ΔA=ΩΔt (Δt time interval)

→A_{N}=A_{N-1}+ΔA (A_{N} and A_{N} the same); the unit vector of level pointer vector:

$${e}_{AN} = [ \begin{matrix}- Sin {A}_{N} \\ Cos {A}_{N} \\ 0\end{matrix} ]$$

Section C—The Rule Governing the Head Mirror Gimbal Angle Command 30.

FIG. 8 shows an analytical description for the commands of the periscope head mirror gimbal angle; wherein

$${x}_{3 AN} = {e}_{x3}^{T} {e}_{AN}$$

$${y}_{3 AN} = {e}_{Y3}^{T} {e}_{AN}$$

$${z}_{3 AN} = {e}_{Z3}^{T} {e}_{AN}$$

$$Normalized as {x}_{3 AN}^{2} + {y}_{3 AN}^{2} + {z}_{3 AN}^{2} = {K}^{2} ; \qquad \begin{matrix} {\overline{x}}_{3 AN} = {x}_{3 AN} / K \\ {\overline{y}}_{3 AN} = {y}_{3 AN} / K \\ {\overline{z}}_{3 AN} = {z}_{3 AZ} / K \\ {AZ}_{AN} = {tan}^{- 1} ( {\overline{y}}_{3 AN} / {\overline{x}}_{3 AN} ) \\ {EL}_{AN} = {tan}^{- 1} ( - {z}_{3 AN} / \sqrt{{x}_{3 AN}^{- 2} + {y}_{3 AN}^{- 2}}\end{matrix}$$

After AZ_{AN} has been controlled, Z₃, <x_{3AN},y_{3AN}> and e_{AN} three vectors are on the same plane; and thus after EL_{AN} has been controlled, the pointer direction is in parallel with e_{AN} and right on the same plane.

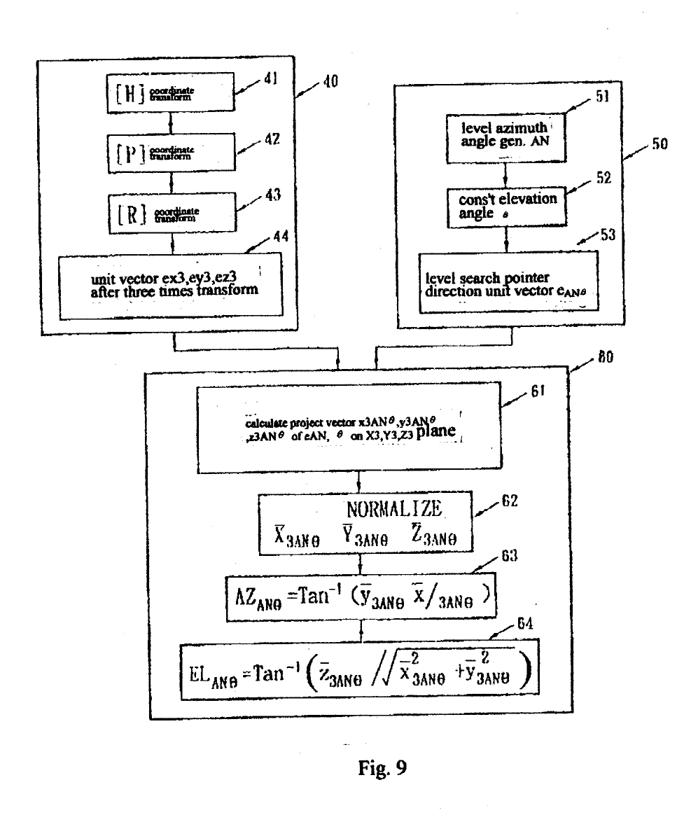

Referring to FIG. 9, the control flow of the level constant elevation angle is shown. The generation of the searching command for the head mirror level constant elevation angle are as follows:

1. Purpose of Control

relative level plane—E=Const=θ (constant elevation angle)

relative level plane—\dot{A}=Const=Ω (constant rotation speed)

for the known platform H, R, P and the requirements of spatial control are E=θ, \dot{A}=Ω, from which the command of the control angle of the head mirror gimbal can be obtained.

2. The Flow Chart of Control

Still referring to FIG. 9, the coordinate transformation module 40 is identical to the coordinate transformation module 10 in FIG. 6. The difference between the level constant elevation angle pointer vector module 50 and the module 20 in FIG. 6 is that there is an additional calculation for the constant elevation angle setting 52 and the original level pointer vector is changed to the level constant elevation pointer vector e_{AN}θ as shown in calculation 53.

Still referring to FIG. 9, during the head mirror gimbal angle command calculation process 60, e_{AN} of the head mirror gimbal angle command calculation 30 in FIG. 6 is replaced by e_{AN}θ. That is, “AN” of the original gimbal command module 30 are all replaced by “AN,θ (or ANθ) and become gimbal command module 60.

3. Rule of Practice

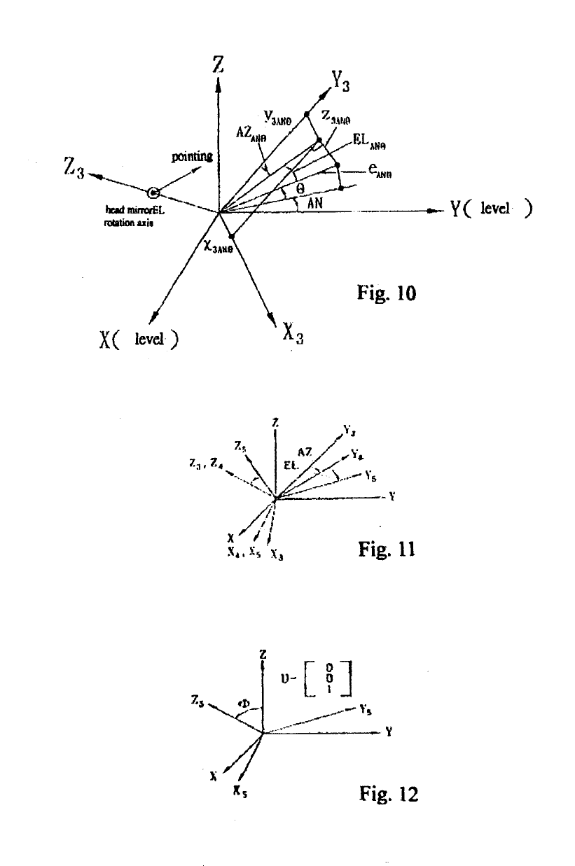

Referring to FIG. 10, is shown a three dimensional analytical diagram of the level constant elevation angle, wherein the level constant elevation pointer unit vector is

$${e}_{AN θ} = [ \begin{matrix}- Cos θ Sin {A}_{N} \\ Cos θ Sin {A}_{N} \\ Sin θ\end{matrix} ] ,$$

where A_{N}=A_{N-1}+ΔA

The level constant elevation pointer vector e_{ANθ} is projected on the three axes as

$${x}_{3 AN} = {e}_{x3}^{T} {e}_{AN θ}$$

$${y}_{3 AN} = {e}_{Y3}^{T} {e}_{AN θ} ; and$$

$${z}_{3 AN} = {e}_{Z3}^{T} {e}_{AN θ}$$

$$Normalization is \sqrt{{x}_{3 AN θ}^{2} + {y}_{3 AN θ}^{2} + {z}_{3 AN θ}^{2}} = G ; wherein \qquad \begin{matrix} {\overline{x}}_{3 AN θ} = {x}_{3 AN 0} / G \\ {\overline{y}}_{3 AN θ} = {y}_{3 AN θ} / G \\ {\overline{z}}_{3 AN θ} = {z}_{3 AN θ} / G \end{matrix}$$

The head mirror gimbal angle command is

$$\begin{matrix}{AZ}_{AN θ} = {tan}^{- 1} ( {\overline{y}}_{3 AN θ} / {\overline{x}}_{3 AN θ} ) \\ {EL}_{AN 0} = {tan}^{1} ( {\overline{z}}_{3 AN} / \sqrt{{x}_{3 AN0}^{- 2} + {y}_{3 AN0}^{- 2}} \end{matrix}$$

After AZ_{ANθ} has been controlled, Z₃ <<(X_{3ANθ},Y_{3ANθ}>> and e_{ANθ} three vectors are on the same level. thus after E L_{ANθ} has also been controlled, that is, after the head mirror EL motor rotation axis rotates to E L_{ANθ}, its pointer direction will be in parallel with e_{ANθ}. In other words, the level azimuth angle of the head mirror motor axis pointer is A_{N}, and the elevation angle is θ.

There is a need to control the orthogonal polarization because the head mirror gimbal of the panoramic periscope is only equipped with rotation and elevation gimbals without roll gimbal, thus the gimbal angle control is unable to maintain the orthogonal polarization of the site vision during level searching scan. Hence there is a need to adopt fast vision processing to perform vision roll coordinate transformation along the pointer direction. Our proposed method to accomplish fast processed vision roll transformation is delineated below.

After the head mirror angle has been controlled by AZ and EL, as shown in FIG. 11, the coordinate axes are changed from X₃, Y₃, Z₃, through X₄, Y₄, Z₄ to become X₅, Y₅, Z₅, and at this time Y₅ axis vector is right on the level. When standing at X, Y, Z coordinate and observing Z₅ along Y₅ has already rolled an angle Φ, as shown in FIG. 12, and thus the angle Φ can be calculated. Vision processing can be used to reverse and rotate angle Φ to maintain the vision polarization Orthogonally as follows:

$$[ \begin{matrix}{X}_{5} \\ {Y}_{5} \\ {Z}_{5}\end{matrix} ] = {[ EL ] [ AZ ] [ R ] [ P ] [ H ] [ \begin{matrix}X \\ Y \\ Z\end{matrix} ]}_{x}$$

X₅²+Y₅²+Z₅²=X²+Y²+Z²

if

$$[ \begin{matrix}X \\ Y \\ Z\end{matrix} ] = {e}_{AN}$$

(level), transformed by prior equation and get

$${[ \begin{matrix}x \\ y \\ z\end{matrix} ]}_{x5} = {[ \begin{matrix}0 \\ 1 \\ 0\end{matrix} ]}_{x5} ;$$

wherein let

$${[ \begin{matrix}x \\ y \\ z\end{matrix} ]}_{x} = {[ \begin{matrix}0 \\ 0 \\ 1\end{matrix} ]}_{x} ,$$

then y₅=0; and

|U|Cos Φ=z₅ |U|Sin Φ=x₅

$$\vert U \vert Cos Φ = {z}_{5} \qquad \vert U \vert Sin Φ = {x}_{5} \qquad ⇒ Φ = {tan}^{- 1} \frac{{x}_{5}}{{z}_{5}}$$

There is also a need for precise reading of the level elevation angle in the actual pointer direction. Because control and vision tracking do exist, the actual head mirror motor axis pointer direction can not be the same as the head mirror gimbal command. Assuming an angle error deviation from the gimbal ΔAZ and ΔEL respectively, then the actual pointer direction V_{P} will be

$${V}_{P} = {[ Δ EL ] [ Δ AZ ] [ \begin{matrix}0 \\ 1 \\ 0\end{matrix} ]}_{GMB} \begin{matrix}= [ \begin{matrix}1 & 0 & 0 \\ 0 & 1 & Δ EL \\ 0 & - Δ EL & 1\end{matrix} ] [ \begin{matrix}1 & Δ AZ & 0 \\ - Δ AZ & 1 & 0 \\ 0 & 0 & 1\end{matrix} ] [ \begin{matrix}0 \\ 1 \\ 0\end{matrix} ] \\ = ( I + [ \begin{matrix}0 & Δ AZ & 0 \\ - Δ AZ & 1 & Δ EL \\ 0 & - Δ EL & 0\end{matrix} ] ) [ \begin{matrix}0 \\ 1 \\ 0\end{matrix} ] \\ = [ \begin{matrix}0 \\ 1 \\ 0\end{matrix} ] + [ \begin{matrix}Δ AZ \\ 0 \\ - Δ EL\end{matrix} ]\end{matrix} ;$$

the deviated error between the actual gimbal pointer direction and the command is (matrix ΔAZ, 0, −ΔEL).

Again, if transformed to level coordinate X, Y, Z then it becomes

$${{{{{[ H ]}^{- 1} [ P ]}^{- 1} [ R ]}^{- 1} [ AZ ]}^{- 1} [ EL ]}^{- 1} [ \begin{matrix}Δ AZ \\ 0 \\ - Δ AZ\end{matrix} ]$$

here, [H],[P],[R],[AZ],[EL] are all orthogonal.

For instance, take [H] as an example, i.e. [H]⁻¹=[H]^{T}; thus

$$\begin{matrix}{[ H ]}^{- 1} = {[ \begin{matrix}Cos H & Sin H & 0 \\ - Sin H & Cos H & 0 \\ 0 & 0 & 1\end{matrix} ]}^{- 1} = [ \begin{matrix}Cos H & - Sin H & 0 \\ Sin H & Cos H & 0 \\ 0 & 0 & 1\end{matrix} ] , and \\ {[ AZ ]}^{- 1} = [ \begin{matrix}Cos AZ & Sin AZ & 0 \\ - Sin AZ & Cos AZ & 0 \\ 0 & 0 & 1\end{matrix} ] = [ \begin{matrix}Cos AZ & - Sin AZ & 0 \\ Sin AZ & Cos AZ & 0 \\ 0 & 0 & 1\end{matrix} ] \\ {[ EL ]}^{- 1} = {[ \begin{matrix}1 & 0 & 0 \\ 0 & Cos EL & Sin EL \\ 0 & - Sin EL & Cos EL\end{matrix} ]}^{- 1} = [ \begin{matrix}1 & 0 & 0 \\ 0 & Cos EL & - Sin EL \\ 0 & Sin EL & Cos EL\end{matrix} ] \\ {[ P ]}^{- 1} = {[ \begin{matrix}1 & 0 & 0 \\ 0 & Cos P & Sin P \\ 0 & - Sin P & Cos P\end{matrix} ]}^{- 1} = [ \begin{matrix}1 & 0 & 0 \\ 0 & Cos P & - Sin P \\ 0 & Sin P & Cos P\end{matrix} ] \\ {[ R ]}^{- 1} = {[ \begin{matrix}Cos R & 0 & Sin R \\ 0 & 1 & 0 \\ - Sin R & 0 & Cos R\end{matrix} ]}^{- 1} = [ \begin{matrix}Cos R & 0 & - Sin R \\ 0 & 1 & 0 \\ Sin R & 0 & Cos R\end{matrix} ]\end{matrix}$$

If ΔAZ=0, ΔEL=0, then the equation below is satisfied

$${[ \begin{matrix}0 \\ 1 \\ 0\end{matrix} ]}_{GMB} = [ EL ] [ AZ ] [ R ] [ P ] [ H ] {e}_{AN θ}$$

This equation represents a constant elevation level scan command vector e_{ANθ}, which is coincident with the gimbal's pointer direction.

Various additional modification of the embodiments specifically illustrated and described herein will be apparent to those skilled in the art in light of the teachings of this invention. The invention should not be construed as limited to the specific form and examples as shown and described. The invention is set forth in the following claims.

What is claimed is:

1. A control method for spatial and level searching applied to a panoramic stabilized periscope, wherein the inputs are platform altitude angles including heading, pitch, roll and spatial level constant elevation angle pointer vector, and the outputs are periscope gimbal azimuth angle (AZ) and elevation angle (EL) command.

2. The method as in claim 1, wherein the relative level spatial unit vector of a three axes platform can be calculated, after said inputted platform attitude has been transformed three times.

3. The method as in claim 1, wherein said inputted spatial pointer level constant elevation angle can be used to calculate its relative level spatial unit vector, and said vector is a level constant speed scan vector.

4. The method as in claim 1, wherein based on solid analytical geometry and projection vector matrix method, said unit vector of the spatial pointer level constant elevation angle projects the vector onto the three axes of platform.

5. The method as in claim 4, wherein said three axes platform projection vector is normalized.

6. The method as in claim 5, wherein said normalized projection vector calculates gimbal azimuth and elevation angle command based on solid geometry and trigonometry.

7. The method as in claim 3, wherein if said spatial level constant elevation angle is zero, then the spatial searching will change to a simple level constant speed searching.

8. The method as in claim 1, wherein an orthogonal polarization control rule of said spatial level searching scan can be implemented by aid from coordinate transformation of vision processing.

9. The method as in claim 6, wherein the errors from said gimbal control and vision tracking can be transformed to actual spatial level pointer errors for correcting the former after said gimbal commands have been controlled.
